(19) United States
(12) Patent Application Publication
(10) Pub. No.: US 2026/0359249 A1
(43) Pub. Date: Nov. 12, 2026

(54) DEVICE FOR DYNAMIC PERIPHERAL HOT-PLUG MANAGEMENT, AND MOTHERBOARD AND COMPUTER, USING THE SAME

(71) Applicant: MARS SEMICONDUCTOR CORP., Hsinchu City (TW)

(72) Inventors: CHUN-CHUAN CHEN, Hsinchu City (TW); TSUNG-MING HO, Hsinchu City (TW); JEN-YI PENG, Hsinchu City (TW)

(21) Appl. No.: 19/314,686

(22) Filed: Aug. 29, 2025

(30) Foreign Application Priority Data
May 8, 2025 (TW) 114117401

(51) Int. Cl. G06F 13/40; G06F 13/42

(52) U.S. Cl. CPC G06F 13/4081; G06F 13/4022; G06F 13/4221

(57) ABSTRACT

A device for dynamic peripheral hot-plug management used in a motherboard of a computer, has first switches configured to connect with external first peripheral devices, and a baseboard management controller electrically connected to the first switches. The baseboard management controller is configured to receive a user-defined platform management interface command reserved by a platform management interface protocol, and to turn on or off one of the first switches according to the platform management interface command, so as to implement virtual hot-plug of the first peripheral device connected to the corresponding first switch. In brief, the device for dynamic peripheral hot-plug management physically disconnects or reconnects the electrical connection between the first peripheral device and the motherboard to achieve virtual hot-plug of the first peripheral device.

### CROSS REFERENCE

The present disclosure claims a priority of a TW patent application 114117401, which is filed on May 8, 2025, wherein all contents of the reference which priority is claimed by the present patent application are included in the present patent application, herein.

### BACKGROUND

### Technical Field

The present disclosure relates to a technology for managing and monitoring a computer, and more particularly, to a device for dynamic peripheral hot-plug management, which is capable of realizing virtual hot-plug of at least one peripheral device without modifying a driver of the peripheral device in an operating system, as well as a motherboard and a computer using the same.

### Related Art

An intelligent platform management interface (IPMI) is a hardware management interface that operates independently of an operating system, mainly used for remote monitoring and management of server systems. The intelligent platform management interface allows system administrators to perform functions such as power control (power-on, reboot, shutdown), hardware monitoring (fan speed measurement, voltage measurement, temperature sensing), and system log recording over a network, even when the host is powered off or the system crashes. These functions are implemented through a baseboard management controller (BMC), which is an embedded controller equipped with independent network connectivity to enable administrators to remotely manage operational status and health information of the server.

In the implementation of hot-plug for peripheral devices, the intelligent platform management interface plays a key role. When a peripheral device is inserted/connected or removed, the baseboard management controller detects the change in real time via sensors and notifies the main system to update resource allocations, such as reassigning input/output (I/O) channels or rescanning peripheral component interconnect express (PCIe) devices. In addition, the baseboard management controller can cooperate with the operating system or firmware to trigger loading or unloading of relevant drivers, ensuring that components can be replaced or added without interrupting system operation. This capability allows the intelligent platform management interface to effectively support high availability and rapid maintenance requirements, making it be an essential management technology in modern data centers.

However, in certain scenarios, such as when a server crash is caused by a faulty peripheral device, although the intelligent platform management interface allows a remote administrator to reboot the server, the same faulty peripheral device may cause the server to crash again after rebooting. Aside from physically removing the faulty peripheral device, another approach is to logically remove it via virtual hot-plug.

The virtual hot-plug allows dynamic and virtual addition or removal of hardware (such as, network cards and hard disks, etc.) without rebooting the system. These changes are not triggered by hardware-level notifications, but rather, are triggered by the virtual hot-plug which is simulated by the hypervisor. However, drivers originally designed for physical hardware may not handle runtime addition or removal of devices. If a driver does not support rescan or resource release logic, the attempt to add or remove virtual devices may fail or even cause system errors. In other words, drivers must be capable of interpreting these signals and responding appropriately. If the driver lacks such logic, it cannot handle these events.

In summary, existing devices for dynamic peripheral hot-plug management, which are based on the intelligent platform management interface protocol, cannot achieve the virtual hot-plug of peripheral devices without modifying the drivers in the operating system. However, modifying peripheral device drivers requires significant time and cost, and each time the operating system is updated, the drivers must be rewritten, which is both labor-intensive and inefficient. Moreover, in current technologies, devices that are virtually removed by the virtual hot-plug still result in power consumption. Although its power usage is lower than that of the peripheral device being actively connected, there is still room for further power-saving improvements.

### SUMMARY

The present disclosure is to provide a device for dynamic peripheral hot-plug management which is capable of performing virtual hot-plug on at least one peripheral device, as well as a motherboard and a computer using the same, so as to address at least one of the technical problems mentioned in the related art.

To achieve at least one objective of the present disclosure, the present disclosure provides a device for dynamic peripheral hot-plug management. The device for dynamic peripheral hot-plug management is applied to a motherboard of a computer, and comprises plurality of first switches and a baseboard management controller. The plurality of plurality of first switches are configured to connect with a plurality of external first peripheral devices, and the baseboard management controller is electrically connected to the plurality of first switches, and supports a platform management interface protocol. The baseboard management controller is configured to receive a user-defined platform management interface command reserved by the platform management interface protocol, and to turn on or off one of the plurality of first switches according to the platform management interface command, so as to implement virtual hot-plug of the first peripheral device connected to the corresponding first switch. When the corresponding first switch is switched from an on state to an off state, an operating system of the computer recognizes that the first peripheral device has been removed, and when the corresponding first switch is switched from the off state to the on state, the operating system of the computer recognizes that the first peripheral device has been connected.

In an exemplary embodiment of the device for dynamic peripheral hot-plug management of the present disclosure, the device for dynamic peripheral hot-plug management further comprises a plurality of second switches, and the plurality of second switches are configured to connect with a plurality of external second peripheral devices. The baseboard management controller is configured to turn on or off one of the plurality of first switches and the plurality of second switches according to the platform management interface command, so as to implement virtual hot-plug of the first peripheral device connected to the corresponding first switch or the second peripheral device connected to the corresponding second switch. When the corresponding second switch is switched from the on state to the off state, the operating system of the computer recognizes that the second peripheral device has been removed, and when the corresponding second switch is switched from the off state to the on state, the operating system of the computer recognizes that the second peripheral device has been connected.

In an exemplary embodiment of the device for dynamic peripheral hot-plug management of the present disclosure, the device for dynamic peripheral hot-plug management further comprises a first bus and a second bus. The first bus is electrically connected to the plurality of first switches and the baseboard management controller, and the second bus is electrically connected to the plurality of second switches and the baseboard management controller.

In an exemplary embodiment of the device for dynamic peripheral hot-plug management of the present disclosure, an interface protocol used by the first peripheral device and an interface protocol used by the second peripheral device are respectively two of following protocols: a peripheral component interconnect express (PCIe) bus protocol, an inter-integrated circuit (I2C) bus protocol, a serial advanced technology attachment (SATA) bus protocol, a universal serial bus (USB) protocol, a serial attached small computer system interface (SAS) bus protocol, a thunderbolt bus protocol, and an IEEE 1394 bus protocol

In an exemplary embodiment of the device for dynamic peripheral hot-plug management of the present disclosure, the platform management interface protocol is an intelligent platform management interface (IPMI) protocol, and the platform management interface command is a user-defined intelligent platform management interface command reserved by the intelligent platform management interface protocol.

In an exemplary embodiment of the device for dynamic peripheral hot-plug management of the present disclosure, the baseboard management controller is in communication with an administrator device, and the platform management interface command is transmitted from the administrator device, wherein the administrator device is a remote terminal device or a local terminal device.

To achieve at least one objective of the present disclosure, the present disclosure provides a motherboard, the motherboard comprises a device for dynamic peripheral hot-plug management, a non-volatile storage device, a sensor and control circuit, a memory socket, and a processor socket. The device for dynamic peripheral hot-plug management comprises a plurality of first switches and a plurality of second switches, wherein the plurality of first switches and the plurality of second switches are respectively configured to connect to a plurality of external first peripheral devices and a plurality of external second peripheral devices. All of the non-volatile storage device, the sensor and control circuit, the memory socket, and the processor socket, are electrically connected to the device for dynamic peripheral hot-plug management. The device for dynamic peripheral hot-plug management is in communication with an administrator device, the administrator device transmits a user-defined platform management interface command reserved by a platform management interface protocol, to the device for dynamic peripheral hot-plug management, and the device for dynamic peripheral hot-plug management is configured to turn on or off one of the plurality of first switches and the plurality of second switches according to the platform management interface command, so as to implement virtual hot-plug of the first peripheral device connected to the corresponding first switch or the second peripheral device connected to the corresponding second switch, without requiring any modification to drivers of an operating system.

In an exemplary embodiment of the motherboard of the present disclosure, the motherboard further comprises a plurality of peripheral component interconnect express (PCIe) slots and a plurality of connection ports. The plurality of peripheral component interconnect express (PCIe) slots are connected to the plurality of first switches, and configured to allow the plurality of first peripheral devices to be inserted and connected. The plurality of connection ports support the inter-integrated circuit (I2C) bus protocol, and they are connected to the plurality of second switches, and configured to allow the plurality of second peripheral devices to be connected.

In an exemplary embodiment of the motherboard of the present disclosure, the motherboard further comprises a system interface, a serial sharer, a network controller, a motherboard serial controller, a serial port, and a network connection port. All of the system interface, the serial sharer, and the network controller, are electrically connected to the device for dynamic peripheral hot-plug management. The motherboard serial controller is electrically connected to the serial sharer, the serial port is electrically connected to the serial sharer, and the network connection port is electrically connected to the network controller.

In an exemplary embodiment of the motherboard of the present disclosure, the motherboard further comprises a system bus and a privacy management bus. The system bus is electrically connected to the system interface, the motherboard serial controller, and the network controller. The memory socket and the processor socket are electrically connected to the device for dynamic peripheral hot-plug management via the privacy management bus.

To achieve at least one objective of the present disclosure, the present disclosure provides a computer. The computer comprises the above motherboard, a memory, and a processor, wherein the memory is inserted into the memory socket, and the processor is inserted into the processor socket.

As described above, compared with the related art, the present disclosure provides a device for dynamic peripheral hot-plug management, as well as a motherboard and a computer using the same, which can perform virtual hot-plug of at least one peripheral device without requiring modification of the driver of the peripheral device in the operating system. As such, an administrator can log in to the computer either locally or remotely via an administrator device to manage and monitor each peripheral device, and can, without being physically present at the site of the computer, remove the peripheral device that causes hazards to the system via virtual hot-plug, and allow a previously removed peripheral device to be re-recognized and utilized by the operating system of the computer.

### BRIEF DESCRIPTION OF DRAWINGS

FIG. 1 is a schematic block diagram of a motherboard having a device for dynamic peripheral hot-plug management according to an exemplary embodiment of the present disclosure.

FIG. 2 is a schematic block diagram of a computer according to an exemplary embodiment of the present disclosure.

### DETAILS OF EXEMPLARY EMBODIMENTS

The following provides a detailed description of exemplary embodiments of the present disclosure with reference to the accompanying drawings. It should be noted, however, that the following implementation details are not intended to limit the scope of the present disclosure, but are provided solely to facilitate understanding by those skilled in the art.

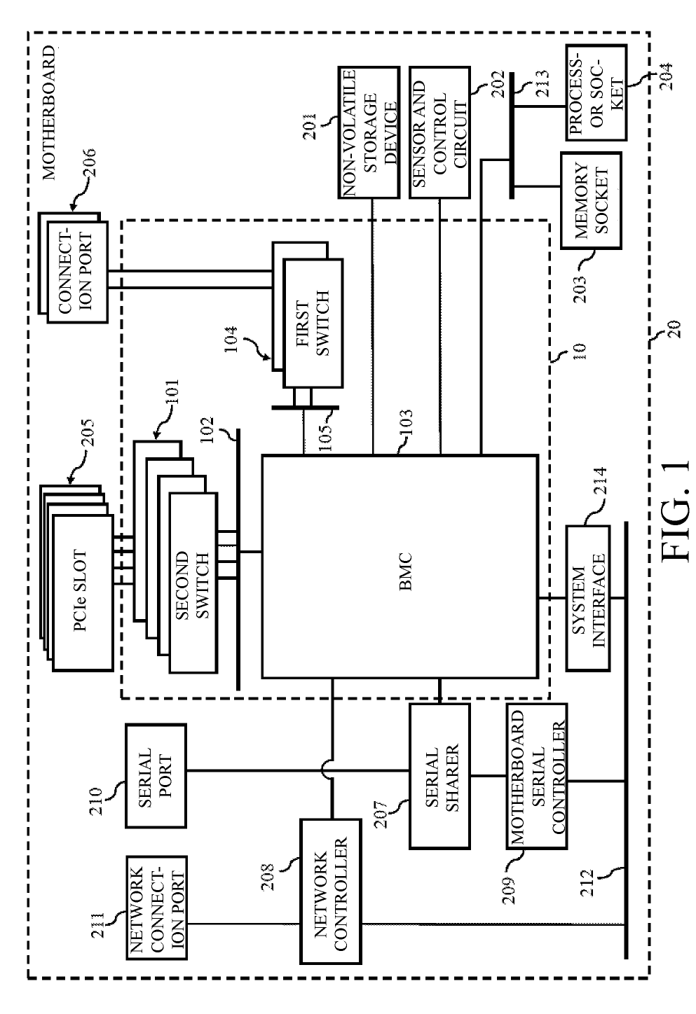

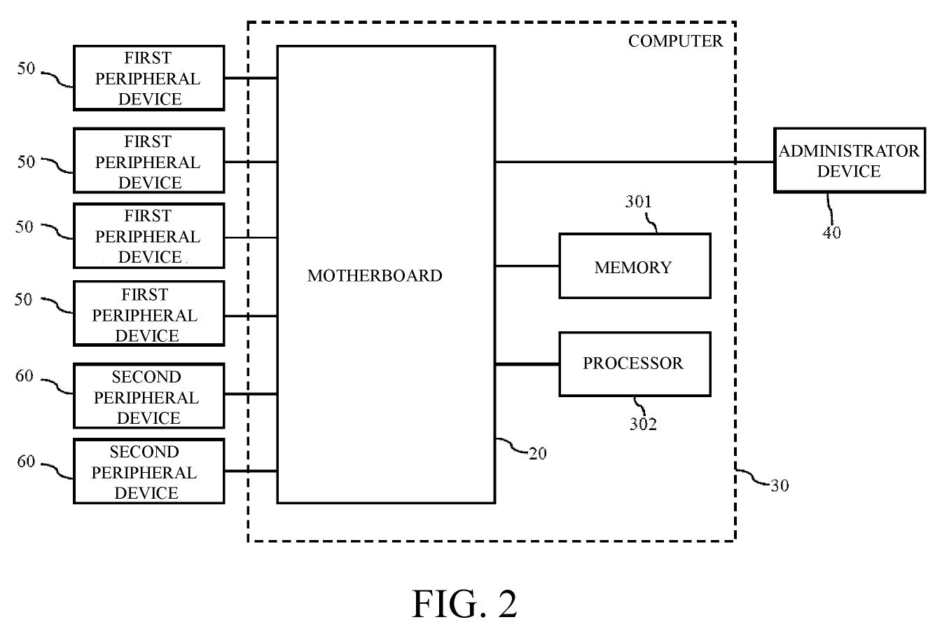

Please refer to FIGS. 1 and 2 at the same time. FIG. 1 is a schematic block diagram of a motherboard having a device for dynamic peripheral hot-plug management according to an exemplary embodiment of the present disclosure, and FIG. 2 is a schematic block diagram of a computer according to an exemplary embodiment of the present disclosure. The motherboard 20 of the present disclosure is used in a computer 30, and the computer 30 is installed with an operating system. The disclosure primarily involves designing an innovative device for dynamic peripheral hot-plug management 10 on the motherboard 20 to enable virtual hot-plug of at least one of peripheral devices without requiring modification of drivers of peripheral devices in an operating system. In other words, the hot-plug operation of the peripheral devices is independent of the type and version of the operating system.

The motherboard 20 at least includes a device for dynamic peripheral hot-plug management 10, a non-volatile storage device 201, a sensor and control circuit 202, a memory socket 203, and a processor socket 204. The device for dynamic peripheral hot-plug management 10 at least includes a plurality of first switches 101 and a plurality of second switches 104, wherein the plurality of first switches 101 and the plurality of second switches 104 are respectively configured to connect to a plurality of external first peripheral devices 50 and a plurality of external second peripheral devices 60. All of the non-volatile storage device 201, the sensor and control circuit 202, the memory socket 203, and the processor socket 204, are electrically connected to the device for dynamic peripheral hot-plug management 10.

Further, the memory socket 203 and the processor socket 204 are configured for insertion of a memory and a processor, respectively. The non-volatile storage device 201, for example flash memory, is used to store relevant information and instructions for the basic input/output system (BIOS). The sensor and control circuit 202 is used to control power restart, host reboot, and fan operation, as well as to sense temperature, voltage, and fan speed.

The device for dynamic peripheral hot-plug management 10 is communicatively connected to an administrator device 40. The administrator device 40 transmits a user-defined platform management interface command, reserved by the platform management interface protocol, to the device for dynamic peripheral hot-plug management 10. The platform management interface protocol can be the intelligent platform management interface (IPMI) protocol, and the command may be a user-defined intelligent platform management interface command reserved by the intelligent platform management interface protocol. However, the present disclosure is not so limited thereto.

The device for dynamic peripheral hot-plug management 10 turns on or off one of the plurality of first switches 101 and the plurality of second switches 104 according to the platform management interface command, thereby implementing virtual hot-plug of the first peripheral device 50 connected to the corresponding first switch 101 or the second peripheral device 60 connected to the corresponding second switch 104, without modifying any of drivers of the operating system.

In the exemplary embodiment, the first peripheral device 50 and the second peripheral device 60 use the peripheral component interconnect express (PCIe) bus protocol and the inter-integrated circuit (I2C) bus protocol, respectively. Accordingly, the motherboard 20 further includes a plurality of peripheral component interconnect express (PCIe) slots 205 and a plurality of connection ports 206. The plurality of peripheral component interconnect express (PCIe) slots 205, which support the peripheral component interconnect express (PCIe) bus protocol and connect to the plurality of first switches 101, are configured to receive the plurality of first peripheral devices 50, i.e., the plurality of first peripheral devices 50 can inserted and connected to the plurality of peripheral component interconnect express (PCIe) slots 205. The plurality of connection ports 206, which support the inter-integrated circuit (I2C) bus protocol and connect to the plurality of second switches 104, are configured to connect the plurality of second peripheral devices 60.

However, the present disclosure is not limited to the interface protocols used by the plurality of first peripheral devices 50 and the plurality of second peripheral devices 60. The interface protocol used by the first peripheral device 50 and the interface protocol used by the second peripheral device 60 are respectively two of following protocols: a peripheral component interconnect express (PCIe) bus protocol, an inter-integrated circuit (I2C) bus protocol, a serial advanced technology attachment (SATA) bus protocol, a universal serial bus (USB) protocol, a serial attached small computer system interface (SAS) bus protocol, a thunderbolt bus protocol, and an IEEE 1394 bus protocol.

Furthermore, the motherboard 20 further comprises a system interface 214, a serial sharer 207, a network controller 208, a motherboard serial controller 209, a serial port 210, and a network connection port 211. All of the system interface 214, the serial sharer 207, and the network controller 208, are electrically connected to the device for dynamic peripheral hot-plug management 10. The motherboard serial controller 209 is electrically connected to the serial sharer 207. The serial port 210 is electrically connected to the serial sharer 207. The network connection port 211 is electrically connected to the network controller 208.

The network connection port 211 may be, for example, an RJ-45 connection port. The serial port 210 may be, but is not limited to, a connection port of a wired or wireless network card conforming to the personal computer memory card international association (PCMCIA) standard or the universal serial bus (USB) standard. When the administrator device 40 serves as a local terminal device, it may be communicatively connected to the device for dynamic peripheral hot-plug management 10 via a cable connecting the administrator device 40 to the serial port 210 or the network connection port 211. When the administrator device 40 serves as a remote terminal device, it may be communicatively connected to the device for dynamic peripheral hot-plug management 10 via a network card connected to the network connection port 211 or the serial port 210.

In addition, the motherboard 20 further includes a system bus 212 and a privacy management bus 213. The system bus 212 is electrically connected to the system interface 214, the motherboard serial controller 209, and the network controller 208. The device for dynamic peripheral hot-plug management 10 communicates and performs data transmission with the motherboard serial controller 209 and the network controller 208 connected to the system bus 212, via the system bus 214. In some instances, the device for dynamic peripheral hot-plug management 10 may directly access and retrieve data from the motherboard serial controller 209 and the network controller 208. The memory socket 203, the processor socket 204, and the device for dynamic peripheral hot-plug management 10 are all electrically connected to the privacy management bus 213. In this manner, the memory socket 203 and the processor socket 204 can be electrically connected to the device for dynamic peripheral hot-plug management 10 through the privacy management bus 213.

Please refer to FIGS. 1 and 2 , the device for dynamic peripheral hot-plug management 10 may further include a baseboard management controller 103, a first bus 102, and a second bus 105. The first bus 102 is electrically connected to a plurality of first switches 101 and the baseboard management controller 103. The second bus 105 is electrically connected to a plurality of second switches 104 and the baseboard management controller 103.

The baseboard management controller 103 supports the platform management interface protocol, such as, but not limited to, the intelligent platform management interface (IPMI) protocol. The baseboard management controller 103 may be communicatively connected to the administrator device 40 and configured to receive the user-defined platform management interface command reserved by the platform management interface protocol, which is transmitted by the administrator device 40. Based on the received platform management interface command, the baseboard management controller 103 selectively turns on or off one of the plurality of first switches 101 and the plurality of second switches 104, so as to implement virtual hot-plug of the first peripheral device 50 connected to the corresponding first switch 101 or the second peripheral device 60 connected to the corresponding second switch 104.

When the corresponding first switch 101 is switched from an on state to an off state, the operating system of the computer 30 recognizes that the first peripheral device 50 has been removed. Conversely, when the corresponding first switch 101 is switched from the state to the on state, the operating system of the computer 30 recognizes that the first peripheral device 50 has been connected. Similarly, when the corresponding second switch 104 is switched from the on state to the off state, the operating system of the computer 30 recognizes that the second peripheral device 60 has been removed. When the corresponding second switch 104 is switched from the off state to the on state, the operating system of the computer 30 recognizes that the second peripheral device 60 has been connected.

Although the motherboard 20 generally includes peripheral devices with two or more different interfaces, the present disclosure is not limited thereto. Accordingly, in another exemplary embodiment, the second switch 104 and the second bus 105 may be omitted. Furthermore, in the exemplary embodiment shown in FIG. 1, although the first bus 102 and the second bus 105 are respectively a peripheral component interconnect express (PCIe) bus and an inter-integrated circuit (I2C) bus, the present disclosure is not limited thereto. In other exemplary embodiments, the first bus 102 and the second bus 105 may respectively be any two of the following: a peripheral component interconnect express (PCIe) bus, an inter-integrated circuit (I2C) bus, a serial advanced technology attachment (SATA) bus, a universal serial bus (USB), a serial attached small computer system interface (SAS) bus, a thunderbolt bus, or an IEEE 1394 bus.

In addition, although FIG. 1 illustrates the use of the first bus 102 and the second bus 105 as bridging buses for the first peripheral device 50 and the second peripheral device 60, respectively, the present disclosure is not limited thereto. In some exemplary embodiments, the first bus 102 and the second bus 105 may be omitted. Instead, each first peripheral device 50 is independently connected to the baseboard management controller 103 via the corresponding first switch 101, and each second peripheral device 60 is independently connected to the baseboard management controller 103 via the corresponding second switch 104.

In summary, the device for dynamic peripheral hot-plug management provided by the present disclosure, as well as the motherboard and the computer utilizing the same, offer the following technical effects: (1) virtual hot-plug of peripheral devices can be achieved without requiring modification of the drivers of the peripheral devices in the operating system, thereby reducing the time and cost associated with driver development and updates; (2) by physically disconnecting the electrical connection between the motherboard and the peripheral device to be virtually removed, power consumption of the peripheral device can be further reduced; (3) the administrator is able to remove a potentially hazardous peripheral device, or restore a previously removed peripheral device for use by the operating system of the computer, via the virtual hot-plug without having to be physically present at the site of the computer, thereby greatly facilitating device management and monitoring; (4) compared to modifying the driver of the peripheral device in the operating system, the technical solution provided by the present disclosure only requires the addition of switches, the integration of necessary buses into the baseboard management controller, and the development of corresponding firmware for the baseboard management controller, all of which entail relatively lower cost; and (5) there is no need to re-modify the driver when the operating system updates, thereby achieving true operating system-independent virtual hot-plug.

The foregoing description summarizes the features of the exemplary embodiments of the present disclosure so that those skilled in the art can better understand aspects of the present disclosure. Those skilled in the art should appreciate that they may readily use the present disclosure as a basis for designing or modifying other processes and structures for realizing the same purposes and/or achieving the same advantages of the exemplary embodiments introduced herein. Those skilled in the art should also recognize that such equivalent constructions do not depart from the spirit and scope of the present disclosure, and that they can be variously modified, substituted, and altered herein without departing from the spirit and scope of the present disclosure.

What is claimed is:

1. A device for dynamic peripheral hot-plug management, applied to a motherboard of a computer, comprising:
a plurality of first switches, configured to connect with a plurality of external first peripheral devices; and
a baseboard management controller, electrically connected to the plurality of first switches, supporting a platform management interface protocol, and configured to receive a user-defined platform management interface command reserved by the platform management interface protocol, and to turn on or off one of the plurality of first switches according to the platform management interface command, so as to implement virtual hot-plug of the first peripheral device connected to the corresponding first switch;
wherein when the corresponding first switch is switched from an on state to an off state, an operating system of the computer recognizes that the first peripheral device has been removed, and when the corresponding first switch is switched from the off state to the on state, the operating system of the computer recognizes that the first peripheral device has been connected.

2. The device for dynamic peripheral hot-plug management according to claim 1, further comprising:
a plurality of second switches, configured to connect with a plurality of external second peripheral devices;
wherein the baseboard management controller is configured to turn on or off one of the plurality of first switches and the plurality of second switches according to the platform management interface command, so as to implement virtual hot-plug of the first peripheral device connected to the corresponding first switch or the second peripheral device connected to the corresponding second switch;
wherein when the corresponding second switch is switched from the on state to the off state, the operating system of the computer recognizes that the second peripheral device has been removed, and when the corresponding second switch is switched from the off state to the on state, the operating system of the computer recognizes that the second peripheral device has been connected.

3. The device for dynamic peripheral hot-plug management according to claim 2, further comprising:
a first bus, electrically connected to the plurality of first switches and the baseboard management controller; and
a second bus, electrically connected to the plurality of second switches and the baseboard management controller.

4. The device for dynamic peripheral hot-plug management according to claim 2, wherein an interface protocol used by the first peripheral device and an interface protocol used by the second peripheral device are respectively two of following protocols: a peripheral component interconnect express (PCIe) bus protocol, an inter-integrated circuit bus protocol, a serial advanced technology attachment (SATA) bus protocol, a universal serial bus (USB) protocol, a serial attached small computer system interface (SAS) bus protocol, a thunderbolt bus protocol, and an IEEE 1394 bus protocol.

5. The device for dynamic peripheral hot-plug management according to claim 1, wherein the platform management interface protocol is an intelligent platform management interface (IPMI) protocol, and the platform management interface command is a user-defined intelligent platform management interface command reserved by the intelligent platform management interface protocol.

6. The device for dynamic peripheral hot-plug management according to claim 1, wherein the baseboard management controller is in communication with an administrator device, and the platform management interface command is transmitted from the administrator device, wherein the administrator device is a remote terminal device or a local terminal device.

7. A motherboard, comprising:
a device for dynamic peripheral hot-plug management, comprising a plurality of first switches and a plurality of second switches, wherein the plurality of first switches and the plurality of second switches are respectively configured to connect to a plurality of external first peripheral devices and a plurality of external second peripheral devices; and
a non-volatile storage device, a sensor and control circuit, a memory socket, and a processor socket, all electrically connected to the device for dynamic peripheral hot-plug management;
wherein the device for dynamic peripheral hot-plug management is in communication with an administrator device, the administrator device transmits a user-defined platform management interface command reserved by a platform management interface protocol, to the device for dynamic peripheral hot-plug management, and the device for dynamic peripheral hot-plug management is configured to turn on or off one of the plurality of first switches and the plurality of second switches according to the platform management interface command, so as to implement virtual hot-plug of the first peripheral device connected to the corresponding first switch or the second peripheral device connected to the corresponding second switch, without requiring any modification to drivers of an operating system.

8. The motherboard according to claim 7, wherein the device for dynamic peripheral hot-plug management further comprises:
a baseboard management controller, electrically connected to the plurality of first switches and the plurality of second switches, supporting the platform management interface protocol, and configured to receive the user-defined platform management interface command reserved by the platform management interface protocol, and to turn on or off one of the plurality of first switches and one of the plurality of second switches according to the platform management interface command;
wherein when the corresponding first switch is switched from an on state to an off state, the operating system of the computer recognizes that the first peripheral device has been removed, and when the corresponding first switch is switched from the off state to the on state, the operating system of the computer recognizes that the first peripheral device has been connected; and when the corresponding second switch is switched from the on state to the off state, the operating system of the computer recognizes that the second peripheral device has been removed, and when the corresponding second switch is switched from the off state to the on state, the operating system of the computer recognizes that the second peripheral device has been connected.

9. The motherboard according to claim 8, wherein the device for dynamic peripheral hot-plug management further comprises:
a first bus, electrically connected to the plurality of first switches and the baseboard management controller and
a second bus, electrically connected to the plurality of second switches and the baseboard management controller.

10. The motherboard according to claim 7, wherein an interface protocol used by the first peripheral device and an interface protocol used by the second peripheral device are respectively two of following protocols: a peripheral component interconnect express (PCIe) bus protocol, an inter-integrated circuit bus protocol, a serial advanced technology attachment (SATA) bus protocol, a universal serial bus (USB) protocol, a serial attached small computer system interface (SAS) bus protocol, a thunderbolt bus protocol, and an IEEE 1394 bus protocol.

11. The motherboard according to claim 7, wherein the platform management interface protocol is an intelligent platform management interface (IPMI) protocol, and the platform management interface command is a user-defined intelligent platform management interface command reserved by the intelligent platform management interface protocol.

12. The motherboard according to claim 7, wherein an interface protocol used by the first peripheral device is a peripheral component interconnect express (PCIe) bus protocol, an interface protocol used by the second peripheral device is an inter-integrated circuit bus protocol, and the motherboard further comprises:
a plurality of peripheral component interconnect express (PCIe) slots, connected to the plurality of first switches, configured to allow the plurality of first peripheral devices to be inserted and connected; and
a plurality of connection ports, supporting the inter-integrated circuit bus protocol, connected to the plurality of second switches, configured to allow the plurality of second peripheral devices to be connected.

13. The motherboard according to claim 12, further comprising:
a system interface, a serial sharer, and a network controller, all electrically connected to the device for dynamic peripheral hot-plug management;
a motherboard serial controller, electrically connected to the serial sharer;
a serial port, electrically connected to the serial sharer; and
a network connection port, electrically connected to the network controller.

14. The motherboard according to claim 13, further comprising:
a system bus, electrically connected to the system interface, the motherboard serial controller, and the network controller; and
a privacy management bus, wherein the memory socket and the processor socket are electrically connected to the device for dynamic peripheral hot-plug management via the privacy management bus.

15. A computer, comprising:
a motherboard, comprising:
a device for dynamic peripheral hot-plug management, comprising a plurality of first switches and a plurality of second switches, wherein the plurality of first switches and the plurality of second switches are respectively configured to connect to a plurality of external first peripheral devices and a plurality of external second peripheral devices; and
a non-volatile storage device, a sensor and control circuit, a memory socket, and a processor socket, all electrically connected to the device for dynamic peripheral hot-plug management;
a memory, inserted into the memory socket; and
a processor, inserted into the processor socket;
wherein the device for dynamic peripheral hot-plug management is in communication with an administrator device the administrator device transmits a user-defined platform management interface command reserved by a platform management interface protocol, to the device for dynamic peripheral hot-plug management, and the device for dynamic peripheral hot-plug management is configured to turn on or off one of the plurality of first switches and the plurality of second switches according to the platform management interface command, so as to implement virtual hot-plug of the first peripheral device connected to the corresponding first switch or the second peripheral device connected to the corresponding second switch, without requiring any modification to drivers of an operating system.

16. The computer according to claim 15, wherein the device for dynamic peripheral hot-plug management further comprises:
a baseboard management controller, electrically connected to the plurality of first switches and the plurality of second switches, supporting the platform management interface protocol, and configured to receive the user-defined platform management interface command reserved by the platform management interface protocol, and to turn on or off one of the plurality of first switches and one of the plurality of second switches according to the platform management interface command;
wherein when the corresponding first switch is switched from an on state to an off state, the operating system of the computer recognizes that the first peripheral device has been removed, and when the corresponding first switch is switched from the off state to the on state, the operating system of the computer recognizes that the first peripheral device has been connected; and when the corresponding second switch is switched from the on state to the off state, the operating system of the computer recognizes that the second peripheral device has been removed, and when the corresponding second switch is switched from the off state to the on state, the operating system of the computer recognizes that the second peripheral device has been connected.

17. The computer according to claim 16, wherein the device for dynamic peripheral hot-plug management further comprises:
a first bus, electrically connected to the plurality of first switches and the baseboard management controller; and
a second bus, electrically connected to the plurality of second switches and the baseboard management controller.

18. The computer according to claim 15, wherein the interface protocol used by the first peripheral device is a peripheral component interconnect express (PCIe) bus protocol, the interface protocol used by the second peripheral device is an inter-integrated circuit bus protocol, and the motherboard further comprises:
a plurality of peripheral component interconnect express (PCIe) slots, connected to the plurality of first switches, configured to allow the plurality of first peripheral devices to be inserted and connected; and
a plurality of connection ports, supporting the inter-integrated circuit bus protocol, connected to the plurality of second switches, configured to allow the plurality of second peripheral devices to be connected.

19. The computer according to claim 18, wherein the motherboard further comprises:
a system interface a serial sharer, and a network controller, all electrically connected to the device for dynamic peripheral hot-plug management;
a motherboard serial controller, electrically connected to the serial sharer;
a serial port, electrically connected to the serial sharer; and
a network connection port, electrically connected to the network controller.

20. The computer according to claim 19, wherein the motherboard further comprises:
a system bus, electrically connected to the system interface, the motherboard serial controller, and the network controller; and
a privacy management bus, wherein the memory socket and the processor socket are electrically connected to the device for dynamic peripheral hot-plug management via the privacy management bus.
